(19) United States
(12) Patent Application Publication
(10) Pub. No.: US 2006/0233676 A1
(43) Pub. Date: Oct. 19, 2006

(54) Glass test tube having protective outer shield

(76) Inventor: Israel Mayer Stein, Chestnut Hill, MA (US)

Correspondence Address: Kenneth J. LuKacher;South Winton Court, Suite 204, 3136 Winton Road South, Rochester, NY, 14623, US

(21) Appl. No.: 11/129,546

(22) Filed: May 13, 2005

Related U.S. Application Data
(63) Continuation-in-part of application No. 11/104,927, filed on Apr. 13, 2005.

(51) Int. Cl. B01L 9/00

(52) U.S. Cl. 422/102

(57) ABSTRACT

An improved test tube with a glass inner surface, layer, or lining, and a protective outer shield (or layer) of a material that protects the test tube from accidental breakage. The protective shield may be of a color which indicates that it has breakage protection. In one embodiment, the protective shield is provided by plastic material which is coated or sprayed on the outer surface of the glass test tube. In another embodiment, the protective shield is provided by one or more layers of wrapped sheet material, such as polyester film. In a further embodiment, a glass tube is inserted into a plastic tube to provide such glass tube with breakage protection. The improved test tube is particularly useful in automatic analyzers that measure erythrocyte sedimentation rate.

This is a continuation-in-part application of U.S. patent application Ser. No. 11/104,927, filed Apr. 13, 2005.

### FIELD OF THE INVENTION

The present invention relates to a test tube having a glass inner surface, layer, or lining and a protective outer shield (or layer), and particularly, to a test tube having a glass inner surface, layer, or lining, and a protective outer shield (or layer) of a material that protects the test tube from accidental breakage. Such outer shield may be of a color indicating that the test tube has such breakage protection. The present invention is especially useful for glass test tubes which are traditionally use in automatic analyzers of medical specimens.

### BACKGROUND OF THE INVENTION

Automatic analyzers and test equipment for measuring erythrocyte sedimentation rate (ESR) of blood are conventionally used in medical laboratories and physician offices. ESR represents the rate red blood cells fall in a period of time, and is often used by physicians in evaluating patient health. Blood is tested in such analyzers is a test tube sealed by a stopper with an anticoagulant. For more information on ESR Testing, see Methods for the Erythrocyte Sedimentation Rate (ESR) Test—Third Edition; Approved Standard, NCCLS Document H2-A3, Vol. 13, No. 8, August 1993. Such analyzers and equipment have optical sensors for reading specimens contained in test tubes. For example, automatic ESR analyzers are sold by Clinical Data, Inc. of Newton, Mass.

Test tubes for ESR testing are preferably made of glass, since the test was developed using glass test tubes and thus are needed to maintain classical reliance on ESR readings by physicians. As a result, glass test tubes are widely used in ESR testing. One problem with glass tubes is that they are prone to accidental breakage if dropped or otherwise mishandled by technicians. This can be especially concerning to technicians handling possible biohazardous blood. Although plastic test tubes have been developed which are not prone to accidental breakage, they are disfavored for ESR testing since they are not of glass. Thus, it would be desirable to provide a test tube with a glass inner surface which has the protection from breakage usually associated with plastic test tubes. Further, it would be desirable if such test tube were distinguishable from typical glass test tubes which lack such protection.

### SUMMARY OF THE INVENTION

Accordingly, it is the principal feature of the present invention to provide an improved test tube with a glass inner surface, layer, or lining, and a protective outer shield (or layer) of a material that protects the glass test tube from accidental breakage.

It is another feature of the present invention to provide an improved test tube with a glass inner surface, layer, or lining having a protective outer shield of a color which indicates that it has breakage protection.

It is a further object of the present invention to provide an improved test tube with a glass inner surface, layer, or lining and an outer layer so that if the glass fractures the contents would be retained within the outer layer.

It is still a further object of the present invention to provide an improved test tube with a glass inner surface, layer, or lining and with a shield material having an outer diameter suitable for loading such test tube into slots of automatic testing equipment.

Briefly described, the test tube embodying the present invention has a glass tube with an open end and dome shaped closed end, and protective material covering the outer surface of the glass tube with or without the protective material covering the closed end.

In one embodiment, the protective material represents a plastic layer of vinyl, or other plastic material, coated or sprayed on the outer surface of the glass tube.

In another embodiment, the protective material represents one or more layers of wrapped sheet material, such as polyester film. For example, such polyester film may be a sheet of Mylar, a polyethyleneterephthalate (PET), available from E. I. Du Pont de Demours and Company.

The protective material may be transparent, or of a color which indicates that the test tube has breakage protection.

The test tube may be considered as a tube shaped container having two layers of different material, i.e., plastic material and a glass material, or a plastic layer with an inner glass layer (or surface or lining), or a glass layer with a plastic outer layer (or surface).

The test tube may alternatively be assembled by providing a first tube of plastic material and then inserting into such first tube a second tube of glass material sized for such insertion.

In addition to providing protection of the glass inner surface from accidental breakage, it is possible that if the test tube is impacted with enough force the glass may fracture, in which case, the outer protective material provides an outer layer containing the contents of any fluid which may be present in test tube. In this manner, two levels of protection may be provided.

Electrostatic charge if present on test tubes when utilized in automatic testing equipment can negatively effect diagnostic testing results. Accordingly, during test tube manufacture and packaging, electrostatic charge build-up on the test tube can be minimized by grounding and electrostatic free packing, respectively.

### DETAILED DESCRIPTION OF THE DRAWINGS

The foregoing and other objects, features, and advantages of the invention will become more apparent from a reading the following detailed description in connection with the accompanying drawings in which:

FIG. 1 is a side view of the glass test tube in accordance with the present invention in which the shield material is shown over the entire outer surface of the test tube; and

FIG. 1A is another side view similar to FIG. 1 in which the shield material is shown over the test tube without such material covering the dome of the closed end;

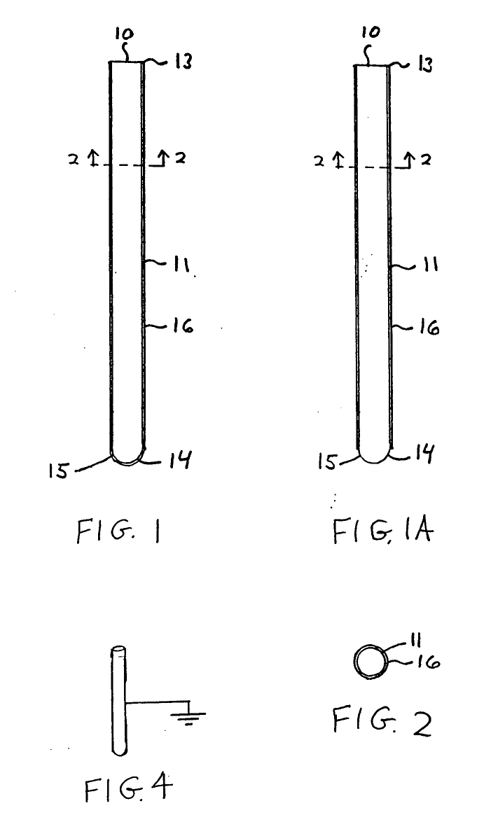

FIG. 2 is a cross sectional view of the glass test tube of FIG. 1 or 1A along lines 2-2;

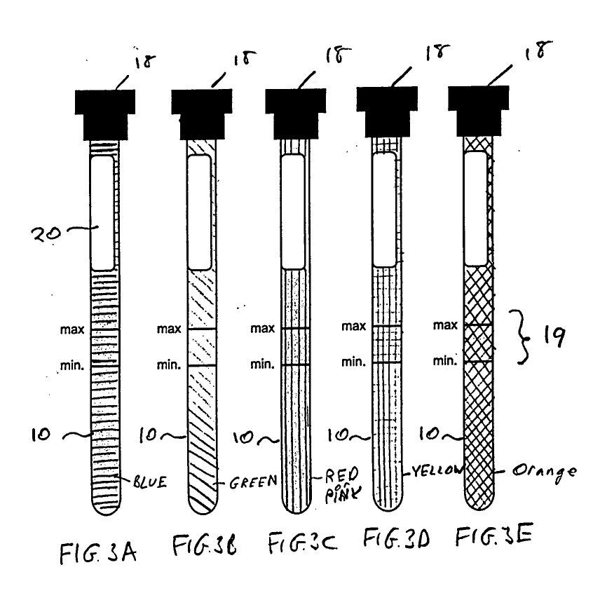

FIGS. 3A-3E are side views, similar to FIG. 1 with five examples of different color of shield material, e.g., blue (FIG. 3A), green (FIG. 3B), red or pink (FIG. 3C), yellow (FIG. 3D), and orange (FIG. 3E); and

FIG. 4 is a schematic diagram showing electrostatic charge dissipation of the test tube of FIG. 1 or 1A.

### DETAILED DESCRIPTION OF THE INVENTION

Referring to FIG. 1, a test tube 10 is shown having a hollow, cylindrical portion 11 with an open end 13 and a closed dome shaped end 14, and protective shield material (or layer) 16 over the outer surface of cylinder portion 11 and the closed end 14. The cylindrical portion 11 with closed end 14 provides test tube 10 with a glass interior surface, layer or lining. Such cylindrical portion 11 with closed end 14 may be provided by typical glass test tube 15, such as used for containing blood or other bodily fluid specimen of a patient, upon which material 16 is applied.

Optionally, the protective material 16 may extend over cylinder portion 11 without covering closed end 14, as shown in FIG. 1A. This may be acceptable since the closed end 14 is often the thickest part of a glass test tube, and as such already provides a level of protection from breakage about end 14. A cross-section of the test tube 10 of FIGS. 1 and 1A is shown in FIG. 2. Although material 16 protects test tube 10 from accidental breakage, if the test tube is impacted with enough force the glass of the test tube may fracture, in which case, material 16 provides an outer layer containing the contents of any fluid which may be present in test tube 10. In this manner, two levels of protection from possible biohazards are provided to users.

Test tube 10 is insertable into a slot of an automatic analyzer for optically measuring contents when contained in the test tube. For example, such automatic analyzer may provide for ESR measurements. Protective material 16 enables light or other radiation, such as IR, used by automatic analyzers and test equipment to pass there through to analyze the contents of the test tube 10. However, the amount of such light may be reduced by material 16, but is still sufficient to enable proper performance of the automatic analyzer. The thickness of material 16 is such that it adds to the outer diameter of cylindrical portion 11, but still permits proper insertion of the test tube 10 into slot(s) of automatic analyzers and test equipment, such as ESR analyzers available from Clinical Data, Inc.

The material 16 may be transparent, or may instead be of color, such as red or blue, to indicate that such test tube 10 has protective material 16, distinguishing the test tube 10 from an unprotected test tube. The addition of color to material 16 can be useful since material 16 if transparent may not be noticeable to the user, and thus the presence of a color assures that the user will select the glass tube with the protection provided by material 16. Glass test tube 10 with five different colors of material 16 is shown for example in FIGS. 3A-3E. In FIGS. 3A-3E, each test tube 10 is shown with a stopper 18 inserted into open end 13, two lines indicating minimum and maximum levels 19 of contents when contained in an upright tube, and a label 20 for identifying the patient and/or test.

In one embodiment, protective material 16 represents a layer of plastic material over cylindrical portion 11 and closed end 14. Such plastic material may be of vinyl, or other plastic material, coated or sprayed on the outer surface of the glass test tube. Preferably, the plastic material is a vinyl compound. To apply the compound, the glass tube 15 once heated is dipped closed end first into heated compound to coat tube 15, and then removed to cure the compound which binds onto the outer surface of the glass of tube 15. Control of temperatures and dip time determines the thickness (or amount) of compound applied. For example, the compound may be Plastisol, but other vinyl compounds may be used. The coating is sufficiently thick to provide adequate protection to the glass tube from breaking if accidentally dropped. For example, the thickness may be about 0.05 to 0.1 millimeters thick or less, but other thicknesses may be used, as desired. Once cured, excess material 16 may be cut away from open end 13, if needed, to provide test tube 10 of FIG. 1. Also, if needed for use in automatic testing equipment or otherwise, the material 16 may be cut away from closed end 14 to provide the test tube of FIG. 1A. Alternatively, the plastic material may be spray coated onto the glass tube. If desired, color additive(s) may be provided to the plastic material prior to application to the test tube to provide color to material 16 as described earlier.

In another embodiment, the protective material 16 represents one or more layers of wrapped sheet material, such as polyester film or other plastic films. For example, such polyester film may be a sheet of Mylar, a polyethyleneterephthalate (PET), available from E. I. Du Pont de Demours and Company. The Mylar sheet may be wrapped around the test tube until the desired thickness is reached. The sheet wrapped may have an adhesive layer which contacts the outer surface of cylindrical portion 11 to adhere the sheet to the outer surface of the glass tube, and then to the outer surface of the wrapped sheet. If needed, excess Mylar may be cut away from open end 13. The resulting test tube 10 is shown, for example, in FIG. 1A. The process for wrapping Mylar sheets onto thin pipette tubing is described in U.S. Pat. Nos. 5,900,091 and 5,173,266. Unlike the pipettes made by these patents in which the entire surface of the pipette is wrapped, the test tube 10 is much larger in diameter, e.g., 8 to 10 millimeters in diameter, and has a closed end which is not covered the Mylar. If desired, color additive(s) may be provided to the Mylar sheet when manufactured, such that the material 16 has the appearance of color, as described earlier.

The resulting product provided by test tube 10 may be considered as a tube shaped container having two layers of different material, i.e., plastic material and a glass material, or a plastic layer with an inner glass layer, or a glass layer with a plastic outer layer.

Alternatively, test tube 10 may be assembled by providing a first tube of plastic material and then inserting in such first tube a second tube of glass material sized for such insertion. When inserted, the open top end of each the first and second tubes aligns with each other, or their open top ends may be machined before or after their engagement to provide such alignment of their open top ends, such that the combination of the two tubes results in the test tube of FIG. 1. The outer surface of the second tube frictionally engages the interior surface of the first tube, or an adhesive may be used between the first and second tubes to provide or secure their engagement. The combination of the first and second tubes protects the second tube from accidental breakage. The first tube may be transparent, or may be of color to indicate the presence of protection from accidental breakage.

Due to the materials used in test tube 10, the test tube can inadvertently be charged, such as an electrostatic charge. When a charged test tube is used in an analyzer, such as an ESR analyzer, the charge may cause problems in the diagnostic testing. This is believed due the charge increasing the surface tension on a liquid when contained in the test tube. Such charging can be eliminated (or at least minimized) during manufacture by grounding the test tube 10 during and/or after assembly to dissipate the charge, such illustrated schematically in FIG. 4. For example, during manufacture the test tube may travel (or contact) a grounded conductive surface or static dissipating brush, or be loaded into slots of an electrically grounded rack, or a combination thereof. After assembly, such charging can be eliminated (or at least minimized) by proper electrostatic free packaging or packing material for storage and/or shipment, such that when removed from such packing the test tubes are ready for use for insertion of fluid and diagnostic testing. Electrostatic free packing may be made of paper or cardboard material or other non-electrostatic charge inducing material. For example, one or more test tubes may be placed in a charge free cardboard box container.

Once assembled, the test tubes may be used as conventional unprotected glass test tube. For example, before being packaged for shipment a stopper may be inserted into the test tube's open end and air removed via a needle through the stopper, and fluid substances may be inserted through the stopper into the test tube (e.g., anticoagulant) for the particular testing to be performed with the test tube.

Optionally, during use of a test tube by the technician, an electrostatic dissipation means, such as used in manufacture of electrostatic sensitive electronics may be used. For example, a grounded conductive arm band worn by the technician, and/or electrically grounded table, racks, or mats having conductive surface(s) which may contact a test tube prior to insertion into an analyzer to further minimize (or eliminate) test tube charge build-up.

From the foregoing description, it will be apparent that there has been provided an improved test tube with a glass inner surface, layer, or lining and having a protective outer shield or layer from glass breakage, and to contain the contents if breakage occurs. Variations and modifications in the herein described test tube in accordance with the invention will undoubtedly suggest themselves to those skilled in the art. Accordingly the foregoing description should be taken as illustrative and not in a limiting sense.

1. A test tube comprising:
a first layer and a second layer, in which said second layer represents the inner layer of the test tube and second first layer represents the outer layer of the test tube, wherein said first layer is of plastic material, and said second layer is of glass material.

2. The test tube according to claim 1 wherein said first layer is of a color.

3. The test tube according to claim 1 wherein said first layer is transparent.

4. The test tube according to claim 1 wherein said test tube is insertable into a slot of an automatic analyzer for optically measuring contents when contained in the test tube.

5. The test tube according to claim 4 wherein said analyzer provides ESR measurements.

6. The test tube according to claim 1 wherein said material of said first layer is of a color indicative of the presence of said test tube having protection from accidental breakage.

7. The test tube according to claim 1 wherein said first layer is coated or sprayed onto said second layer.

8. The test tube according to claim 1 wherein said first layer is formed by one or more wrapped layer of polyester sheet material.

9. The test tube according to claim 1 wherein one or more of said test tubes are packaged in electrostatic free material for shipment or storage.

10. The test tube according to claim 1 further comprising means for dissipating electrostatic charge from the test tube.

11. The test tube according to claim 1 wherein said material of said first layer protects the second layer from accidental breakage, and said first layer contains any contents of the test tube if breakage of the second layer does occurs.

12. The test tube according to claim 1 wherein said second layer is provided by a glass tube.

13. (canceled)

14. (canceled)

15. (canceled)

16. (canceled)

17. (canceled)

18. (canceled)

19. The test tube according to claim 1 wherein said plastic layer is formed or shaped over said second layer.

20. A system for storing and shipping test tubes comprising:
one or more of said test tubes, each of said test tubes having an inner glass layer and an outer plastic layer; and
an electrostatic free container into which said one of more test tubes are received.

21. A sample container comprising:
a glass test tube; and
material formed or shaped upon said glass tube to cover at least a substantial outer portion thereof for protecting said glass test tube from accidental breakage, wherein said material allows passage of light or other radiation to a sample when contained in said glass test tube to enable optical analysis of said sample.

22. The sample container according to claim 21 wherein said material is of a color indicative of the presence of said glass test tube having protection from accidental breakage.

23. The sample container according to claim 21 wherein said material is of plastic.

24. The sample container according to claim 21 wherein said glass test tube with said material has an outer diameter enabling placement of said sample container in a slot of an automatic analyzer.
